(19) United States
(12) Patent Application Publication
(10) Pub. No.: US 2009/0125942 A1
(43) Pub. Date: May 14, 2009

(54) Method and Apparatus for Providing Program Guide

(76) Inventors: Scott Allan Kendall, Lexington, KY (US); Anthony Edward Stuart, Zionsville, IN (US)

Correspondence Address: Robert D. Shedd;Thomson Licensing LLC, PO Box 5312, PRINCETON, NJ, 08543-5312, US

(21) Appl. No.: 11/920,487

(22) PCT Filed: May 5, 2006
(86) PCT No.: PCT/US06/17268

§ 371 Date: Nov. 16, 2007

Related U.S. Application Data
(60) Provisional application No. 60/681,867, filed on May 17, 2005.

(51) Int. Cl. H04N 5/445

(52) U.S. Cl. 725/44; 725/39

(57) ABSTRACT

A method and apparatus provide an on-screen program guide that uses its space in an efficient manner by shifting program information within the program guide by relatively small time increments. According to an exemplary embodiment, the apparatus includes a memory operative to store data that enables the program guide. A processor is operative to enable display of a portion of the program guide including program information covering a first time interval including a current time. The program guide has time information in a first axis and channel information in a second axis. The processor is further operative to cause the program information to be shifted along the first axis by a second time interval if an elapsed time equals the second time interval. The second time interval is less than thirty minutes.

### CROSS REFERENCE TO RELATED APPLICATION

This application claims priority to and all benefits accruing from a provisional application filed in the United States Patent and Trademark Office on May 17, 2005, and there assigned Ser. No. 60/681,867.

### BACKGROUND OF THE INVENTION

1. Field of the Invention

The present invention generally relates to program guides used by apparatuses such as television signal receivers, and more particularly, to a method and apparatus for providing a program guide that uses its space in an efficient manner by shifting program information within the program guide by relatively small time increments.

2. Background Information

A program guide is an interactive, on-screen display feature that displays information analogous to television listings found in local newspapers or other print media. The information contained in a program guide may include programming characteristics such as channel number, program title, start time, end time, and a brief description of a program's content. Program guides may for example be arranged in a two-dimensional grid format with time information on one (e.g., horizontal) axis and channel information on the other (e.g., vertical) axis.

With an on-screen program guide having the aforementioned grid format, program information within the program guide typically moves (i.e., is shifted) to the right at predetermined times corresponding to each hour or half hour mark. For example, if the current time is 8:29 PM, the far left side of the program guide may be displayed with programs having a start time of 8:00 PM. This means that twenty-nine minutes of time is essentially wasted on the far right side of the program guide. Accordingly, this type of program guide does not use its space as efficiently as possible. As a result, the program guide does not, for example, inform users regarding future programming options as promptly as possible.

One possible solution to the foregoing problem is to simply increase the display time interval of the program guide, and thereby display more program information. For example, the program guide could be modified to provide up to two hours of program information. This solution, however, may be undesirable since the size of the text within the program guide would be correspondingly reduced, thereby making it more difficult to read. This problem would be even more pronounced in geographical areas such as Europe where programs are often ten minutes and sometimes as little as five minutes in length.

Accordingly, there is a need for a method and apparatus for providing a program guide that addresses the foregoing problems, and is thereby capable of using its space in a more efficient manner. The present invention addresses these and/or other issues.

### SUMMARY OF THE INVENTION

In accordance with an aspect of the present invention, a method for providing a program guide is disclosed. According to an exemplary embodiment, the method comprises a step of enabling display of a portion of the program guide including program information covering a first time interval including a current time. The program guide has time information in a first axis and channel information in a second axis. The method further comprises a step of causing the program information to be shifted along the first axis by a second time interval if an elapsed time equals the second time interval. The second time interval is less than thirty minutes.

In accordance with another aspect of the present invention, an apparatus for providing a program guide is disclosed. According to an exemplary embodiment, the apparatus comprises memory means for storing data that enables the program guide, and processing means for enabling display of a portion of the program guide including program information covering a first time interval including a current time. The program guide has time information in a first axis and channel information in a second axis. The processing means causes the program information to be shifted along the first axis by a second time interval if an elapsed time equals the second time interval. The second time interval is less than thirty minutes.

In accordance with another aspect of the present invention, a television signal receiver is disclosed. According to an exemplary embodiment, the television signal receiver comprises a memory operative to store data that enables a program guide, and a processor operative to enable display of a portion of the program guide including program information covering a first time interval including a current time. The program guide has time information in a first axis and channel information in a second axis. The processor is further operative to cause the program information to be shifted along the first axis by a second time interval if an elapsed time equals the second time interval. The second time interval is less than thirty minutes.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a diagram providing further details of the apparatus of FIG. 1 according to an exemplary embodiment of the present invention;

FIG. 3 is a diagram of an on-screen program guide according to an exemplary embodiment of the present invention; and

FIG. 4 is a flowchart illustrating steps for providing a program guide according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

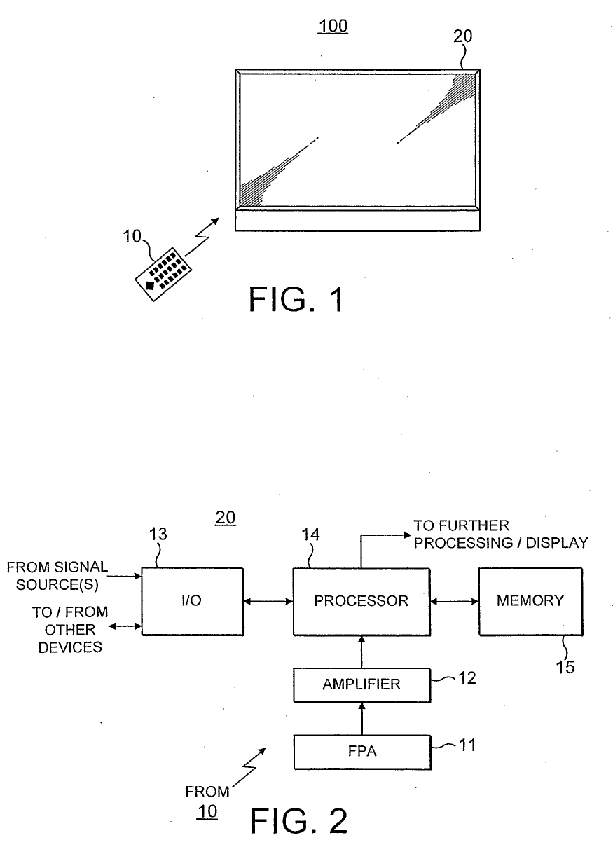

Referring now to the drawings, and more particularly to FIG. 1, an exemplary environment 100 suitable for implementing the present invention is shown. As indicated in FIG. 1, environment 100 comprises user input means such as user input device 10, and electronic apparatus such as apparatus 20. According to an exemplary embodiment, apparatus 20 is embodied as a television signal receiver, but may be embodied as any type of device or apparatus capable of providing an on-screen program guide.

User input device 10 is operative to generate and output control signals that control the operation of apparatus 20 and/or other devices. According to an exemplary embodiment, user input device 10 includes a plurality of input keys and outputs control signals in a wired and/or wireless (e.g., via infrared or radio frequency (RF) link, etc.) manner responsive to user depression of its input keys. User input device 10 may for example be embodied as a handheld remote control device, wired and/or wireless keyboard, integrated control panel of apparatus 20, and/or other user input device.

Apparatus 20 is operative to receive signals including audio, video and/or data signals in analog and/or digital format from one or more signal sources such as terrestrial, cable, satellite, internet and/or other signal sources and to provide aural and/or visual outputs corresponding to these received signals. Apparatus 20 is also operative to process received signals and provide the resulting processed signals to one or more other devices, and to receive signals from other devices. According to an exemplary embodiment, apparatus 20 is capable of providing an on-screen program guide that uses its space in an efficient manner by shifting program information within the program guide by relatively small time increments. Further details regarding the on-screen program guide of apparatus 20 will be provided later herein.

Referring to FIG. 2, a block diagram providing further details of apparatus 20 of FIG. 1 according to an exemplary embodiment of the present invention is shown. Apparatus 20 of FIG. 2 comprises front panel means such as front panel assembly (FPA) 11, coupling means such as amplifier 12, and input/output (I/O) means such as I/O block 13, processing means such as processor 14, and memory means such as memory 15. Some of the foregoing elements of FIG. 2 may be embodied using ICs, and some elements may for example be included on one or more ICs. For clarity of description, certain conventional elements associated with apparatus 20 such as certain control signals, power signals and/or other elements may not be shown in FIG. 2.

FPA 11 is operative to receive user inputs from user input device 10, and to output signals corresponding to the user inputs to amplifier 12. According to an exemplary embodiment, FPA 11 receives signals, such as IR and/or RF signals, from user input device 10 and generates corresponding signals which are output to amplifier 12. Amplifier 12 is operative to amplify the signals provided from FPA 11 for output to processor 14.

I/O block 13 is operative to perform I/O functions of apparatus 20. According to an exemplary embodiment, I/O block 13 is operative to receive signals such as audio, video and/or data signals in analog and/or digital format from one or more signal sources such as terrestrial, cable, satellite, internet and/or other signal sources. I/O block 13 is also operative to output processed signals to one or more other devices, and to receive signals from such devices.

Processor 14 is operative to perform various signal processing and control functions of apparatus 20. According to an exemplary embodiment, processor 14 processes the audio, video and/or data signals provided from I/O block 13 by performing functions including tuning, demodulation, forward error correction, and transport processing functions to thereby generate digital data representing audio, video and/or data content. The digital data produced from such processing functions may be provided for further processing and/or output.

Processor 14 is also operative to execute software code that enables display of an on-screen program guide according to principles of the present invention. According to an exemplary embodiment, processor 14 is operative to cause program information within the program guide to be shifted along a time axis of the program guide by a pre-defined time interval which is less than thirty minutes. Such program information may be shifted in response to an expiration of the pre-defined time interval and/or in response to a user navigating within the program guide via user input device 10. As a result of the program information being shifted, one or more program titles included in the program information may be truncated. Further details regarding processor 14 and the aforementioned program guide will be provided later herein. Processor 14 is also operative to perform and/or enable other functions of apparatus 20 including, but not limited to, processing user inputs made via user input device 10, reading and writing data from and to memory 15, and/or other operations.

Memory 15 is operatively coupled to processor 14 and performs data storage functions of apparatus 20. According to an exemplary embodiment, memory 15 stores data including, but not limited to, software code, on-screen display (e.g., program guide, etc.) data, user setup data, and/or other data.

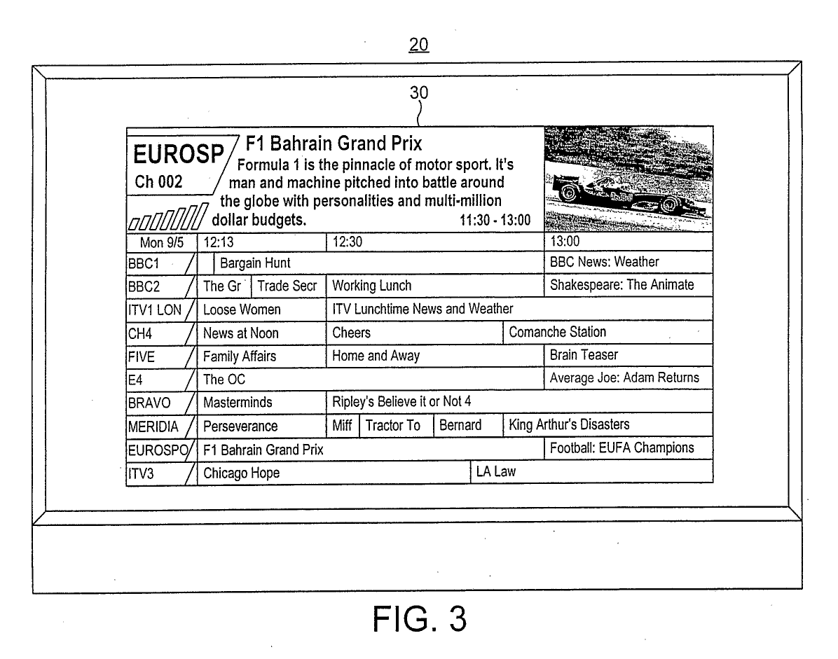

Referring now to FIG. 3, a diagram of an on-screen program guide 30 according to an exemplary embodiment of the present invention is shown. For purposes of example and explanation, program guide 30 of FIG. 3 illustrates program information for a channel line-up available in the U.K. As shown in FIG. 3, program guide 30 includes time information in a horizontal axis and channel information in a vertical axis. The current time is 12:13 PM and the display window shows approximately seventy minutes (i.e., 12:13 PM to 1:23 PM) of program information. If program guide 30 were displayed in a conventional manner, the far left side of the display window would correspond to 12:00 PM instead of the current time. Program guide 30 of FIG. 3 includes hour and half-hour marks for user reference.

According to principles of the present invention, program information (i.e., program titles) within program guide 30 is shifted along the horizontal axis by a pre-defined time interval which is less than thirty minutes, and may be shifted by a single column of pixels. For example, assuming that the seventy minute display window of program guide 30 includes four hundred and twenty columns of pixels, this corresponds to approximately one pixel column every ten seconds (i.e., 420 pixel columns/70 minutes=6 pixel columns/1 minute=1 pixel column/10 seconds). That is, program information within the display window of program guide 30 may be shifted to the right at the rate of one pixel column every ten seconds. It is noted that while program information within the display window of the program guide 30 is shifted to the right, the program guide 30 appears to a user as moving from the right to the left.

However, since the display of program guide 30 may require a noticeable amount of time to be updated, program information within the display window of program guide 30 may be shifted at a slower rate, such as every minute or every several minutes. According to an exemplary embodiment, the time interval at which program information within the display window of program guide 30 is shifted may be adjustable (e.g., within a prescribed range) by users during a set-up process for apparatus 20. Also according to an exemplary embodiment, the time interval at which program information within the display window of program guide 30 is shifted is less than or equal to the shortest program time duration included in program guide 30. For example, if the shortest program time duration included in program guide 30 is five minutes, program information within program guide 30 may be shifted in accordance with a time interval that is less than or equal to five minutes. In any event, the time interval at which program information within the display window of program guide 30 is shifted to the right may be set as a matter of design choice and/or user preference. Program information within the display window of program guide 30 may also be shifted and updated in response to a user navigating within program guide 30 (e.g., navigating up and/or down through the program information). The physical distance, Y, that the program information within the display window of program guide 30 is shifted during each time interval, T1, can be calculated as follows: Y=(X*T1/T2), where X represents the physical length of the display window and T2 represents the time interval covered by the display window.

Although program guide 30 of FIG. 3 shows approximately seventy minutes of program information within its display window, the time interval covered by this display window may be different. According to an exemplary embodiment, the time interval covered by the display window of program guide 30 may be adjustable (e.g., within a prescribed range) by users during a set-up process for apparatus 20 so that users have more control of the display resolution of program guide 30. Also according to an exemplary embodiment, the time interval covered by the display window of program guide 30 is between sixty and ninety minutes. In any event, the time interval covered by the display window of program guide 30 may be set as a matter of design choice and/or user preference.

Program guide 30 of FIG. 3 solves a problem caused by limited screen resolution. In particular, by shifting program information within program guide 30 by relatively small time increments, more program information can be communicated to users than if the program information is shifted at half-hour or hour mark in a conventional manner. Moreover, shifting program information within program guide 30 in smaller time increments may improve the readability of program guide 30 in geographical areas such as Europe where television programs may start at any time in five minute increments, as discussed below.

As indicated in FIG. 3, many programs included in program guide 30 such as “Working Lunch” and “Cheers” start on the half-hour. However, other programs do not. For example, the UK version of “Cheers” is only twenty-five minutes long so that the program “Comanche Station” starts at 12:55 PM. Moreover, the program “Miff . . . ” is only a five minute program followed by two ten minute programs (i.e., “Tractor To . . . ” and “Bernard”) on the same channel. At 12:35, the program “Miff . . . ” should have disappeared from the display window according to the principles of the invention. The readability is improved because, at 12:35, the program “Miff . . . ” should have finished and a user has no need to see that program title on the display window any more.

According to principles of the present invention, program titles may be truncated based on the time interval covered by the display window of program guide 30. In particular, a program title may be truncated more with a display window covering a longer time interval (e.g., ninety minutes, etc.) than a display window covering a shorter time interval (e.g., sixty or seventy minutes, etc.). For example, the program “Tractor To . . . ” shown in the exemplary seventy minute display window of program guide 30 in FIG. 3 may be displayed as “Tract . . . ” if the display window were expanded to ninety minutes, thereby making the program title less likely to be recognized. One option for addressing this issue is to display text with a smaller size, although this could make it more difficult for a user to recognize a program title. Using a display window covering a shorter time interval may also address this issue, although a shorter time interval would reduce the amount of program information users can view at a given time.

As program information within the display window of program guide 30 is shifted to the right, the programs at the far left side of the display window have smaller time windows and their titles may be truncated (or size-reduced) until they are so small that no letters are visible. This is actually not a problem since any program with only a few minutes left is probably not a program of interest. Moreover, a user can always navigate within program guide 30 via user input device 10 to highlight a program of interest and thereby see a description of the program in the information banner at the top of program guide 30. On the right side of the display window, the time windows for programs get larger as the program information is shifted to the right, thereby allowing more of the program titles to be shown.

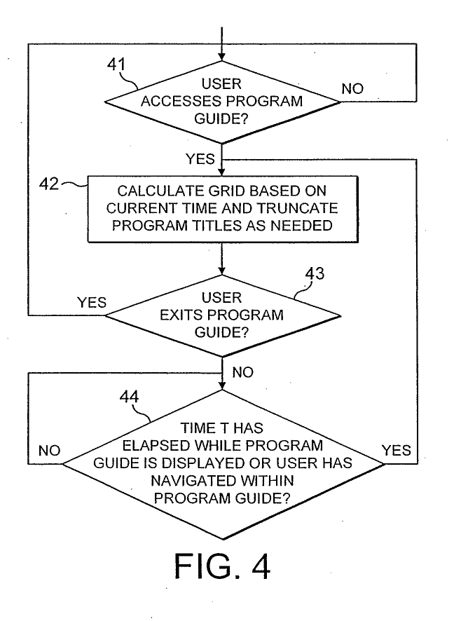

Referring now to FIG. 4, a flowchart 40 illustrating steps for providing an on-screen program guide according to an exemplary embodiment of the present invention is shown. For purposes of example and explanation, the steps of FIG. 4 will be described with reference to apparatus 20 of FIGS. 1 and 2, and program guide 30 of FIG. 3. The steps of FIG. 4 are exemplary only, and are not intended to limit the present invention in any manner.

At step 41, apparatus 20 detects whether a user accesses program guide 30. According to an exemplary embodiment, a user may access program guide 30 at step 41 by providing one or more predetermined inputs to apparatus 20 via user input device 10 which are detected by processor 14. For example, the user may press a “GUIDE” or “MENU” key of user input device 10 at step 41 to access program guide 30. As indicated in FIG. 4, step 41 is repeatedly performed until it is detected that program guide 30 is accessed.

Once program guide 30 is accessed by a user at step 41, process flow advances to step 42 where apparatus 20 displays program guide 30 by calculating a grid for program guide 30 based on the current time and truncating program titles as needed. According to an exemplary embodiment, processor 14 calculates the grid for program guide 30 by adding the time interval covered by the display window of program guide 30 to the current time. As previously indicated herein, the time interval covered by the display window of program guide 30 may be set as a matter of design choice and/or user preference. According to the exemplary embodiment shown in FIG. 3, the time interval covered by the display window of program guide 30 is approximately seventy minutes. Accordingly, processor 14 adds seventy minutes to the current time to calculate the grid for program guide 30 at step 42. Once the grid for program guide 30 is calculated, processor 14 causes program information corresponding to the grid to be displayed within the display window of program guide 30. When displaying this program information at step 42, program titles may be truncated as previously described herein.

From step 42, process flow advances to step 43 where apparatus 20 detects whether the user exits program guide 30. According to an exemplary embodiment, the user may exit program guide 30 at step 43 by providing one or more predetermined inputs to apparatus 20 via user input device 10 which are detected by processor 14. For example, the user may press an “EXIT” key of user input device 10 to exit program guide 30 at step 43. As indicated in FIG. 4, if the user exits program guide 30 at step 43, process flow loops back to step 41.

Alternatively, if the user does not exit program guide 30 at step 43, process flow advances to step 44 where apparatus 20 determines whether a pre-defined time interval T has elapsed while program guide 30 is displayed, or whether the user has navigated within program guide 30. According to an exemplary embodiment, processor 14 begins a timing function each time program guide 30 is displayed (or updated), and thereby detects when time interval T elapses at step 44. Time interval T of step 44 represents the time interval at which program information (i.e., program titles) is shifted along the horizontal axis of program guide 30. As previously indicated herein, this pre-defined time interval T is less than thirty minutes, and may be as small as the time represented by a single column of pixels. In general, time interval T of step 44 may be set as a matter of design choice and/or user preference. Processor 14 also detects at step 44 whenever a user navigates within program guide 30. As indicated in FIG. 4, step 44 is repeatedly performed until processor 14 detects that either pre-defined time interval T has elapsed while program guide 30 is displayed, or that the user has navigated within program guide 30. Once processor 14 detects at least one of these conditions at step 44, process flow loops back to step 42 where processor 14 re-calculates the grid for program guide 30 based on the current time, as previously described herein.

As described herein, the present invention provides a method and apparatus for providing a program guide that uses its space in an efficient manner by shifting program information within the program guide by relatively small time increments. The present invention may be applicable to various apparatuses, either with or without an integrated display device. Accordingly, the phrase “television signal receiver” as used herein may refer to systems or apparatuses including, but not limited to, television sets, computers, handheld devices, or monitors that include an integrated display device, and systems or apparatuses such as set-top boxes, video cassette recorders (VCRs), digital versatile disk (DVD) players, video game boxes, personal video recorders (PVRs), computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for providing a program guide, comprising steps of:
enabling display of a portion of said program guide including program information covering a first time interval including a current time, said program guide having time information in a first axis and channel information in a second axis; and
causing said program information to be shifted along said first axis by a second time interval if an elapsed time equals said second time interval, wherein said second time interval is less than thirty minutes.

2. The method 4 of claim 1, wherein said first time interval is adjustable by a user.

3. The method of claim 1, wherein said first time interval is between sixty and ninety minutes.

4. The method of claim 1, wherein said second time interval is adjustable by a user.

5. The method of claim 1, wherein said second time interval is less than or equal to five minutes.

6. The method of claim 1, further comprised of re-calculating a grid for said program guide in response to a user navigating within said program guide

7. The method of claim 1, wherein at least one program title is truncated in response to said program information being shifted along said first axis by said second time interval.

8. An apparatus for providing a program guide, comprising:
memory means for storing data that enables said program guide;
processing means for enabling display of a portion of said program guide including program information covering a first time interval including a current time, said program guide having time information in a first axis and channel information in a second axis; and
said processing means causing said program information to be shifted along said first axis by a second time interval if an elapsed time equals said second time interval, wherein said second time interval is less than thirty minutes.

9. The apparatus of claim 8, wherein said first time interval is adjustable by a user.

10. The apparatus of claim 8, wherein said first time interval is between sixty and ninety minutes.

11. The apparatus of claim 8, wherein said second time interval is adjustable by a user.

12. The apparatus of claim 8, wherein said second time interval is less than or equal to five minutes.

13. The apparatus of claim 8, wherein said processing means (14) re-calculates a grid for said program guide in response to a user navigating within said program guide.

14. The apparatus of claim 8, wherein at least one program title is truncated in response to said program information being shifted along said first axis by said second time interval.

15. A television signal receiver, comprising:
a memory operative to store data that enables a program guide;
a processor operative to enable display of a portion of said program guide including program information covering a first time interval including a current time, said program guide having time information in a first axis and channel information in a second axis; and
said processor being further operative to cause said program information to be shifted along said first axis by a second time interval if an elapsed time equals said second time interval, wherein said second time interval is less than thirty minutes.

16. The television signal receiver of claim 15, wherein said first time interval is adjustable by a user.

17. The television signal receiver of claim 15, wherein said first time interval is between sixty and ninety minutes.

18. The television signal receiver of claim 15, wherein said second time interval is adjustable by a user.

19. The television signal receiver of claim 15, wherein said second time interval is less than or equal to five minutes.

20. The television signal receiver of claim 15, wherein said processor is further operative to re-calculate a grid for said program guide in response to a user navigating within said program guide.

21. The television signal receiver of claim 15, wherein at least one program title is truncated in response to said program information being shifted along said first axis by said second time interval.
